(19) United States
(12) Patent Application Publication
(10) Pub. No.: US 2023/0086844 A1
(43) Pub. Date: Mar. 23, 2023

(54) DOOR STABILIZER

(71) Applicant: Best Process Solutions, Inc., Brunswick, OH (US)

(72) Inventor: Edward A. Verbos, Hinckley, OH (US)

(21) Appl. No.: 17/482,520

(22) Filed: Sep. 23, 2021

(51) Int. Cl. E05F 7/04; E05F 7/00

(52) U.S. Cl. CPC E05F 7/04; E05F 7/005; E05Y 2900/132; E05Y 2600/626

(57) ABSTRACT

A pair of door stabilizer bracket units, each unit including a clamping mechanism for gripping a vertical frame member of a separate one of a pair of double swinging doors that are closed when the vertical frame members are adjacent one another, the doors being hinged along a respective vertical line remote from a respective one of said vertical frame members, the bracket units when the doors are closed having parts that interengage and limit relative vertical movement of said doors at said vertical frame members while not substantially impeding opening and closing movement of the doors or requiring manipulation of a unit on the respective door to release the bracket units from any interengagement such that the bracket units can be simply disengaged from any interengagement by door opening movement.

### BACKGROUND OF THE INVENTION

The invention relates to wheeled carts with hinged doors subjected to vibration and, in particular, to improvements to make the doors less susceptible to vibration induced failure.

### PRIOR ART

Wheeled carts for transporting packages in a fulfillment center or like warehouse or in a highway trailer can be subjected to vibration, either in a shaker to increase package density or on roadways with irregular surfaces. Doors, typically of steel tube frame and steel wire mesh construction, on such carts can fail at their hinges by vibration induced fatigue.

### SUMMARY OF THE INVENTION

The invention provides hardware that can be retrofitted on existing cart doors to reduce the vibration amplitude in the doors and thereby alleviate the fatigue failure of the doors. The disclosed hardware is economical, easily installed and does not require extra effort when the doors are manually opened or closed. Ideally the hardware has provision for clamping on adjacent swinging door frame elements of a pair of double swing mounted doors. As disclosed, the hardware or bracketry can be identical for each door thereby saving cost, inventory and avoiding mistakes in assembly.

In the disclosed embodiment, the inventive brackets have fingers that interengage fingers of an opposed bracket to reduce relative vertical motion of the closed double doors, thereby reducing fatigue producing stress in the door hinge area.

### BRIEF DESCRIPTION OF THE DRAWING

FIG. 1 is an isometric illustration of a wheeled cart on which the invention is employed;

FIG. 1A is an enlarged isometric view of the door stabilizer of the invention installed on an upper set of double doors;

FIG. 1B is an enlarged isometric view of the door stabilizer of the invention installed on a lower set of double doors;

FIG. 2 is a front isometric view of a bracket forming a part of the door stabilizer;

FIG. 3 is a top view of the bracket;

FIG. 4 is a rear isometric view of the bracket; and

FIG. 5 is an elevational view of a pair of interengaged brackets.

### DESCRIPTION OF THE PREFERRED EMBODIMENT

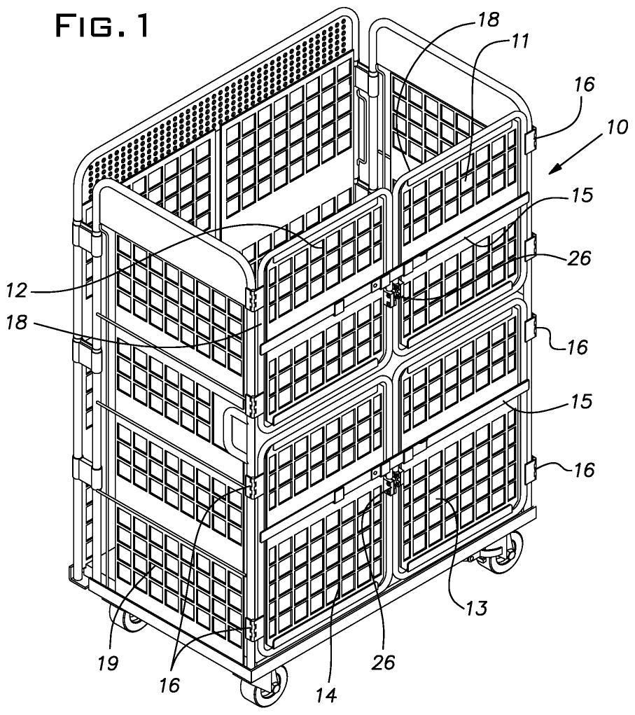

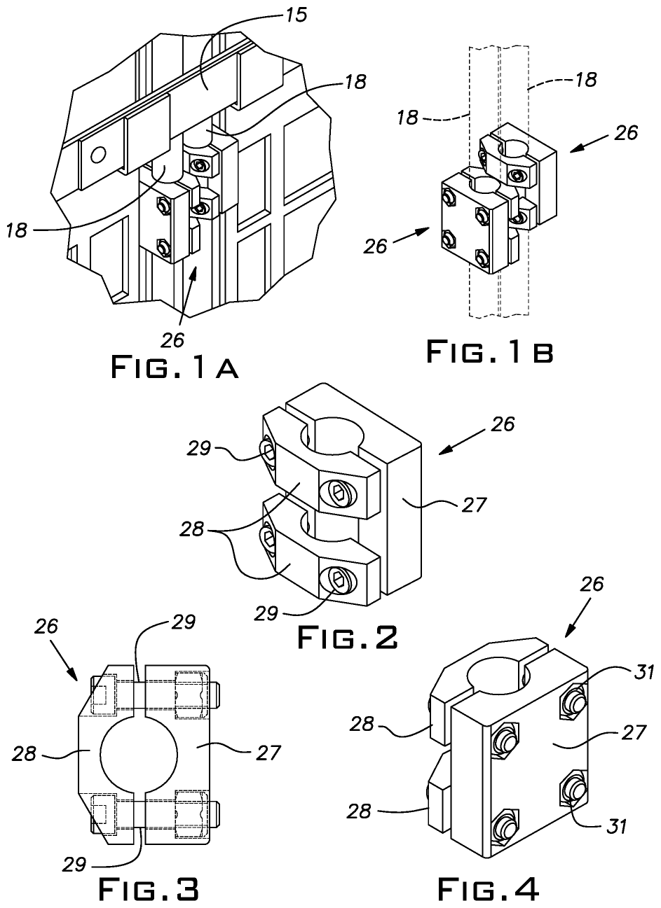

A wheeled cart 10 with an upper pair of double doors 11, 12 and a lower pair of double doors 13, 14 is shown in FIG. 1. Hinges 16 of the doors 11-14 permit the doors to swing about vertical axii. Pivotal latch bars 15 (FIG. 1A) releasably hold pairs 11, 12; 13, 14 of the doors closed. The doors, typically, have a peripheral frame 18 of round steel tubing supporting steel welded wire mesh 19. The cart is used to store and/or transport packages small in size relative to the capacity of the cart 10.

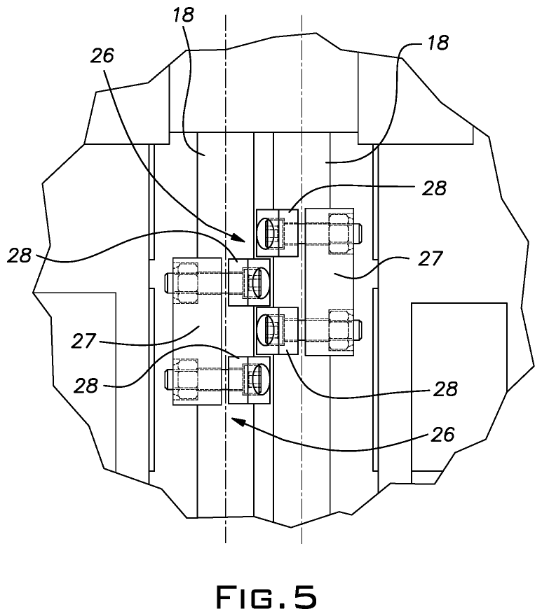

Door stabilizer units 26 of the invention are shown in FIGS. 2-4. Each unit or bracket 26 comprises a base 27 and two caps or clamping members 28. The clamping members 28 are secured to the base 27 by socket head cap screws 29. The screws 29 are received in clearance counterbores in the members 28 and aligned counterbores in the base 27, carrying nuts 31. The screws 29 serve as a clamping mechanism when tightened in the threaded nuts 31. By way of example, but not limitation, the base and clamp members 27, 28 may be zinc die castings. Each of the base 27 and clamping members 28 has a partial cylindrical recess to fit snugly on a section of a door frame 18.

The stabilizer units or brackets 26 are assembled on the vertical free sections of the frame 18 remote from the hinges 16 of each of a pair of doors 11, 12 and 13, 14. The vertical position of one bracket 26 is higher than the adjacent other bracket 26 so that the clamping members 28 interfit with one another and permit only negligible relative vertical movement (e.g. ± 1/16 inch) of one door 11 or 13 to the other 12 or 14. The adjacent clamping members 28 are interengaged such that the clamping members, serving as fingers 28 of the two stabilizer units 26 are intermeshed.

It has been found that the stabilizer units 26, being interengaged when the respective double doors are closed as described, serve to greatly reduce vibration of the doors when the cart 10 is intentionally vibrated to increase the density of the packages on the cart or vibrated in highway transport, and the potential for fatigue failure at or around the door hinges 16.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A pair of door stabilizer bracket units, each unit including a clamping mechanism for gripping a vertical frame member of a separate one of a pair of double swinging doors that are closed when the vertical frame members are adjacent one another, the doors being hinged along a respective vertical line remote from a respective one of said vertical frame members, the bracket units when the doors are closed having parts that interengage and limit relative vertical movement of said doors at said vertical frame members while not substantially impeding opening and closing movement of the doors or requiring manipulation of a unit on the respective door to release the bracket units from any interengagement such that the bracket units can be simply disengaged from any interengagement by door opening movement.

2. A method of stabilizing a pair of double doors each with a steel tube perimeter frame, comprising attaching bracket units to each vertical door frame sections remote from a hinge of the respective door, the bracket units being constructed and arranged to prevent substantial vertical relative movement between the doors when closed while allowing the doors to be opened or closed without separate manipulation of either of said bracket units on their respective door and with one of the bracket units having an extension that interengages the other bracket unit when the doors are closed.

3. A bracket unit to stabilize swing double doors comprising a base with a groove on an interior face and an opposing clamping member having a groove on an inner face, a screw adapted to draw said base and clamping member together while said grooves are aligned and confining a frame of one of the doors, the bracket being configured to interengage with an identical bracket on a frame of the other door.
